(19) United States
(12) Patent Application Publication
(10) Pub. No.: US 2015/0185159 A1
(43) Pub. Date: Jul. 2, 2015

(54) ANALYSIS SYSTEM, AUXILIARY APPARATUS FOR THE SAME, MOBILE TERMINAL AND CONTROL PROGRAM THEREOF

(71) Applicants: Konomu Hirao, Osaka (JP); TTM Co., Ltd., Osaka (JP); SYSTEMROAD Co., Ltd., Kyoto-shi (JP)

(72) Inventors: Takahiko Morita, Kyoto (JP); Konomu Hirao, Osaka (JP)

(21) Appl. No.: 14/595,784

(22) Filed: Jan. 13, 2015

Related U.S. Application Data
(63) Continuation of application No. PCT/JP2014/084720, filed on Dec. 27, 2014.

(30) Foreign Application Priority Data
Dec. 31, 2013 (JP) 2013-273747

(51) Int. Cl. G01N 21/78; G06K 9/00

(52) U.S. Cl. CPC G01N 21/78; G06K 9/00134

(57) ABSTRACT

An analysis system is configured by combining a mobile terminal equipped with a camera, and an auxiliary apparatus for analysis. The auxiliary apparatus includes a placing section on which the mobile terminal is placed. A chip mounting section and a light source are provided below the placing section. The placing section includes a light passing section for making transmitted light or reflected light in a coloring reaction portion, emitted from the light, incident on the camera. The camera is used as a light receiving section. A data processing section included in the mobile terminal is used as a concentration calculating processing section and, when the light in the coloring reaction portion passes through the light passing section and is made incident on the camera, is capable of executing the concentration calculation processing on the basis of data on a picked-up image signal output from the camera.

### BACKGROUND OF THE INVENTION

1. Field of the Invention

The present invention relates to an analysis system used for analyzing a desired sample such as blood and a technique concerning the analysis system.

2. Description of the Related Art

As conventional examples of an analysis system, there is an analysis system described in Japanese Patent Application Laid-open No. 2011-021918 and Japanese Patent Application Laid-open No. 2010-276443.

In this conventional analysis system, a chip for analysis is used. The chip for analysis includes, for example, a reaction chamber, to the inner surface of which a predetermined reagent is applied. When a sample such as blood is supplied to the reaction chamber, the sample and the reagent are mixed to cause a coloring reaction. It is possible to calculate concentration of a specific component of the sample by testing an optical characteristic (e.g., absorbance) of a portion of the coloring reaction.

However, the conventional technique has deficiencies explained below.

The conventional analysis system specifically includes a chip mounting section for mounting the chip for analysis, a light source for irradiating light on the coloring reaction portion in the reaction chamber, a light receiving section that receives transmitted light or reflected light in the coloring reaction portion, and a concentration calculation processing section that calculates concentration of a specific component in a sample on the basis of data on a signal output from the light receiving section. Further, for example, a display for outputting and displaying an analysis result, a printer, and a communication circuit for performing data transmission to the printer and the like are also provided as appropriate. When the analysis system including such a large number of devices is manufactured, manufacturing costs of the analysis system tend to be high. In spreading and promoting points of care in medical institutions, various facilities, and the like, it is desired to reduce the manufacturing costs of the analysis system as much as possible to reduce economical burdens on users and the like. In the past, the size of an entire apparatus tends to be large. Inconvenience often occurs in handling of the apparatus.

### SUMMARY OF THE INVENTION

The present invention has been devised in view of the circumstances and it is an object of the present invention to streamline a configuration and suitably attain a reduction in manufacturing costs, a reduction in the size, and the like of an entire analysis system.

In order to solve the problems, the present invention takes technical measures explained below.

An analysis system provided according to a first aspect of the present invention is an analysis system including: a chip mounting section on which a chip for analysis for causing a coloring reaction between a sample and a reagent is mounted; a light source for irradiating light on a coloring reaction portion of the chip for analysis mounted on the chip mounting section; a light receiving section that receives transmitted light or reflected light in the coloring reaction portion, emitted from the light source, and that outputs a signal corresponding to an amount of the received light; and a concentration calculation processing section that executes concentration calculation processing on a specific component in the sample on the basis of data on the signal output from the light receiving section. The analysis system is configured by combining a mobile terminal equipped with a camera and an auxiliary apparatus for analysis. The auxiliary apparatus for analysis includes a placing section, on which the mobile terminal can be placed, and has a configuration in which the chip mounting section and the light source are provided below the placing section. The mounting section includes a light passing section for making the transmitted light or the reflected light in the coloring reaction portion, emitted from the light source, incident on the camera of the mobile terminal in a state in which the mobile terminal is placed on the placing section. The camera of the mobile terminal being used as the light receiving section. A data processing section that is included in the mobile terminal is used as the concentration calculating processing section and, when the transmitted light or the reflected light in the coloring reaction portion passes through the light passing section and is made incident on the camera, is capable of executing the concentration calculation processing on the basis of data on a picked-up image signal output from the camera.

Specific examples of the mobile terminal include a cellular phone, a smartphone, and a portable tablet terminal.

With such a configuration, effects explained below are obtained.

The camera and the data processing section of the mobile terminal configure the light receiving section and the concentration calculation processing section of the conventional analysis system. Therefore, in the auxiliary apparatus for analysis, it is unnecessary to provide means equivalent to the light receiving section and the concentration calculation processing section. As means for outputting an analysis result, it is also possible to adopt means for transmitting data on an analysis result to an appropriate printer on the outside from the mobile terminal and causing the printer to print-output the data or apply means for causing a display included in the mobile terminal to display the data. Therefore, it is possible to simplify the configuration of the auxiliary apparatus for analysis. On the other hand, the mobile terminal does not need to be specialized as a device configuring the analysis system. A smartphone or the like owned by a user can be effectively used as the mobile terminal. In this way, when compared with the conventional analysis system in which all the devices are specialized as dedicated devices, the analysis system according to the present invention has a streamlined configuration in which the mobile terminal is efficiently and effectively used. The analysis system according to the present invention is desirable in reducing substantial manufacturing costs of the entire system to be lower than the manufacturing costs in the past and spreading and promoting points of care. It is also possible to facilitate a reduction in the size of the entire analysis system and improve handlability of the analysis system.

In the present invention, preferably, the auxiliary apparatus for analysis further includes a communication circuit capable of performing wired or wireless data communication with the mobile terminal. A control signal is transmitted to the communication circuit from the mobile terminal to control a light emitting operation of the light source.

With such a configuration, the light emitting operation of the light source of the auxiliary apparatus for analysis is controlled via the mobile terminal. Therefore, it is possible to attain simplification and facilitation of the operation of the entire analysis system and improve convenience of use.

In the present invention, preferably, the mobile terminal is capable of transmitting data concerning a result of the concentration calculation processing to a printer designated in advance, an apparatus or a device other than the printer, or to a desired address on a network.

With such a configuration, it is possible to easily transmit the data concerning the result of the concentration calculation processing to an external device or the like, cause the external apparatus to print-output the data, and store and manage the data. As a data transmission function of the mobile terminal, a function originally included in the mobile terminal only has to be used. Therefore, it is unlikely that complication of the configuration is caused.

In the present invention, preferably, the camera is enabled to pick up an image of a range wider than the coloring reaction portion in the chip for analysis and obtain, as data on a picked-up image by the camera, data on a main image obtained by collectively picking up images of the coloring reaction portion and a peripheral region of the coloring reaction portion. The data processing section selects data on an image of the coloring reaction portion from the data on the main image and executes the concentration calculation processing on the basis of the selected data.

With such a configuration, when the camera of the mobile terminal picks up an image of the coloring reaction portion of the chip for analysis, the camera only has to pick up images of not only the coloring reaction portion but also the peripheral region of the coloring reaction portion. Therefore, it is unnecessary to highly accurately perform alignment of the camera and the coloring reaction portion such that the camera picks up an image of only the coloring reaction portion. When a plurality of the coloring reaction portions are provided in the chip for analysis, it is also possible to perform processing for collectively picking up images of the plurality of coloring reaction portions and analyzing the individual coloring reaction portions. This is advantageous in increasing processing speed. It is also unnecessary to move the positions of the light source and the camera of the mobile terminal to places respectively corresponding to the plurality of coloring reaction portions by using a dedicated motion mechanism.

An auxiliary apparatus for analysis provided according to a second aspect of the present invention is an auxiliary apparatus for analysis including: a chip mounting section on which a chip for analysis for causing a coloring reaction on a sample and a reagent is mounted; a light source for irradiating light on a coloring reaction portion of the chip for analysis mounted on the chip mounting section; and a placing section on which a mobile terminal equipped with a camera can be placed. The chip mounting section and the light source are provided below the placing section. The mounting section includes a light passing section for making the transmitted light or the reflected light in the coloring reaction portion incident on the camera of the mobile terminal in a state in which the mobile terminal is placed on the placing section.

The auxiliary apparatus for analysis having such a configuration is suitable for constructing the analysis system provided according to the first aspect of the present invention and is desirable in obtaining effects same as the effects explained concerning the analysis system of the present invention.

A mobile terminal provided according to a third aspect of the present invention is a mobile terminal including: a camera; and a data processing section capable of executing data processing on a picked-up image signal output from the camera. The mobile terminal is used in combination with the auxiliary apparatus for analysis provided according to the second aspect of the present invention to constitute an analysis system capable of executing concentration calculation processing on a specific component in a sample. The data processing section sets, when predetermined operation is performed, the mobile terminal in an analysis processing adaptive mode and is capable of executing, during the setting of the analysis processing adaptive mode, when transmitted light or reflected light in a coloring reaction portion, emitted from a light source on a side of the auxiliary apparatus for analysis, is made incident on the camera and an image of the coloring reaction portion is picked up, the concentration calculation processing on the basis of data on the picked-up image signal output from the camera.

With such a configuration, by combining the mobile terminal with the auxiliary apparatus for analysis provided according to the second aspect of the present invention, it is possible to appropriately construct the analysis system provided according to the first aspect of the present invention. The mobile terminal is desirable in obtaining effects same as the effects explained concerning the analysis system of the present invention.

In the present invention, preferably, the mobile terminal is capable of performing data communication with a communication circuit included in the auxiliary apparatus for analysis. When the analysis processing adaptive mode is set, the data processing section transmits a command signal for activating a light source of the auxiliary apparatus for analysis to the communication circuit. Then, after confirmation is made that the coloring reaction portion is constructed in the chip for analysis mounted on a chip mounting section of the auxiliary apparatus for analysis, executes control of activating the camera to pick up an image of the coloring reaction portion.

With such a configuration, it is possible to execute, according to the control of the data processing section of the mobile terminal, an operation for driving to light the light source of the auxiliary apparatus for analysis and an operation for picking up an image of the coloring reaction portion by the camera of the mobile terminal. Therefore, facilitation of operation is attained and convenience of use is improved.

In the present invention, preferably, in a stage before the chip for analysis is mounted on the chip mounting section of the auxiliary apparatus for analysis, a preliminary test for testing an output characteristic of the camera is possible. In the preliminary test, the camera is caused to receive reaction between from the light source. When the camera receives the light, an amount of light received by the camera is set to change in a plurality of stages. Values of a plurality of output signals output from the camera are checked according to the received light amount that changes in the plurality of stages. After the preliminary test, data correction for correcting the values of the plurality of output signals to conform to a linear relation in a correlation with the received light amounts in the plurality of stages of the camera is calculated. When transmitted light or reflected light in the coloring reaction portion is received by the camera and a picked-up image signal is output from the camera, data on the output signal or data corresponding to the data is corrected on the basis of the data for correction. Concentration of a specific component in the sample is calculated on the basis of the data after the correction.

With the configuration explained above, effects explained below are obtained.

In a characteristic of an output signal from a camera of a mobile terminal such as a smartphone, a relation with a received light amount of the camera is usually nonlinear from the viewpoint of allowing human eyes to clearly view a picked-up image. If, for example, absorbance of a coloring reaction portion is calculated on the basis of the output signal having such a characteristic of the camera and concentration calculation processing for a specific component is directly performed, a value of a calculation processing result includes a large error. On the other hand, with the configuration, it is possible to perform the correction for correcting the received light amount of the camera and the output signal to a substantially liner relation and reducing the error explained above. It is possible to correct an analysis result to a correct value.

In the present invention, preferably, in the preliminary test, an operation in which the amount of light received by the camera changes in the plurality of stages is performed by causing the reaction between from the light source to pass through each of a plurality of ND filters having different transmittances and making the light incident on the camera, and changing an exposure time of the camera in a plurality of stages, or changing a light emission time of the light source in a plurality of stages.

With such a configuration, it is possible to easily and appropriately realize the operation in which the received light amount of the camera changes in the plurality of stages in the preliminary test.

A control program for a mobile terminal provided according to a fourth aspect of the present invention is a control program for a mobile terminal stored, in a mobile terminal including a camera and a data processing section capable of executing data processing on a picked-up image signal output from the camera, in a storing section of the data processing section and used for constituting an analysis system capable of executing concentration calculation processing on a specific component in a sample by using the mobile terminal in combination with the auxiliary apparatus for analysis provided according to the second aspect of the present invention. The control program for the mobile terminal includes data for causing the data processing section to execute: a step of setting the mobile terminal in an analysis processing adaptive mode when predetermined operation is performed; and a step of executing, during the setting of the analysis processing adaptive mode, when transmitted light or reflected light in a coloring reaction portion, emitted from a light source on a side of the auxiliary apparatus for analysis, is made incident on the camera and an image of the coloring reaction portion is picked up, the concentration calculation processing on the basis of data on the picked-up image signal output from the camera.

With such a configuration, it is possible to suitably realize the mobile terminal provided according to the third aspect of the present invention.

Other features and advantages of the present invention will be made clearer from explanation of embodiments of the invention performed below with reference to the accompanying drawings.

### BRIEF DESCRIPTION OF THE DRAWINGS

FIG. 1 is a perspective view showing an example of an analysis system according to the present invention;

FIG. 2 is a sectional view schematically showing the schematic configuration of the analysis system shown in FIG. 1;

FIG. 3 is a block diagram showing the hardware configuration of a mobile terminal configuring the analysis system shown in FIG. 1;

FIG. 4A is a plan view showing an example of a chip for analysis used in the analysis system shown in FIG. 1;

FIG. 4B is a IVB-IVB sectional view of FIG. 4A;

FIG. 5A is a plan view showing an example of a chip for preliminary test used in the analysis system shown in FIG. 1;

FIG. 5B is a VB-VB sectional view of FIG. 5A;

FIG. 6 is a plan view showing another example of the chip for preliminary test used in the analysis system shown in FIG. 1;

FIG. 7 is a flowchart showing an example of a basic operation processing procedure of a sample analysis executed by the analysis system shown in FIG. 1;

FIGS. 8A and 8B are explanatory diagrams schematically showing an example of a region, an image of which is picked up by a camera of the mobile terminal in the analysis system shown in FIG. 1;

FIG. 9 is a main part enlarged view schematically showing an example of a picked-up image by the camera;

FIG. 10 is a diagram showing a relation between pixels in a row L1 of the image shown in FIG. 9 and signal levels of the pixels;

FIG. 11 is a flowchart for explaining an example of an operation processing procedure for specifying a reaction chamber in the picked-up image by the camera;

FIG. 12 is a flowchart for explaining an example of an operation processing procedure by a data processing section of the mobile terminal;

FIG. 13 is a flowchart for explaining an example of an operation processing procedure executed in an auxiliary apparatus for analysis;

FIGS. 14A and 14B are explanatory diagrams showing examples of a method for creating data for correction;

FIGS. 15A and 15B are explanatory diagrams showing examples of a method for creating data for correction;

FIGS. 16A and 16B are explanatory diagrams showing examples of a method for creating data for correction;

FIGS. 17A and 17B are explanatory diagrams showing comparative examples of absorbance calculated by performing data correction and absorbance calculated without performing the data correction;

FIGS. 18A and 18B are explanatory diagrams showing comparative examples of absorbance calculated by performing data correction and absorbance calculated without performing the data correction;

FIG. 19 depicts time charts of another example of a method for obtaining data for correction;

FIG. 20 depicts time charts of another example of the method for obtaining data for correction.

### DESCRIPTION OF THE PREFERRED EMBODIMENTS

Preferred embodiments of the present invention are specifically explained with reference to the drawings.

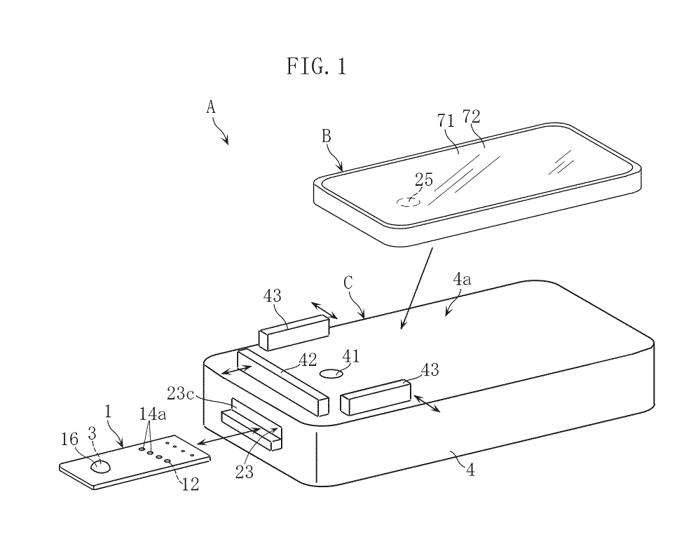

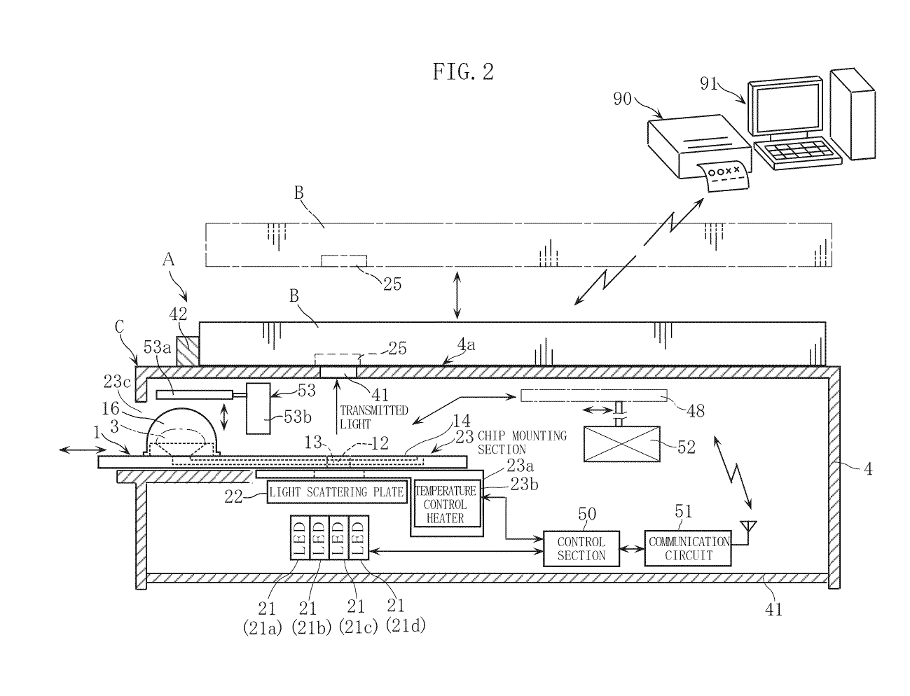

An analysis system A shown in FIGS. 1 and 2 is configured by combining a mobile terminal B including a camera 25 and an auxiliary apparatus for analysis C. The analysis system A is used for analyzing a sample 3 using a chip for analysis 1. As the sample 3, for example, blood is used. However, as explained below, a type of the sample is not limited to this. The mobile terminal B is, for example, a smartphone.

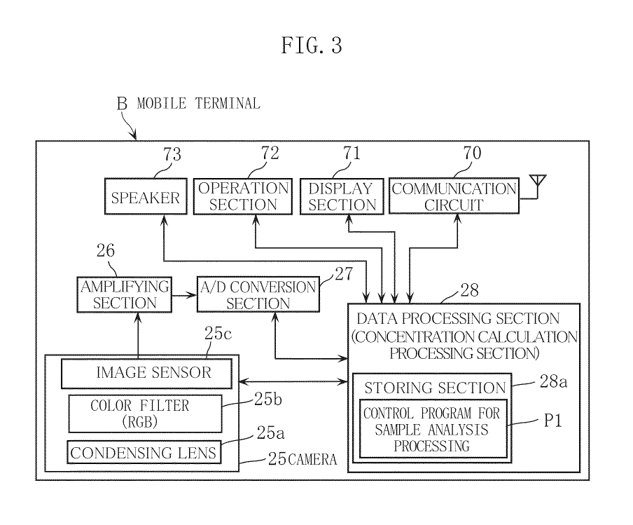

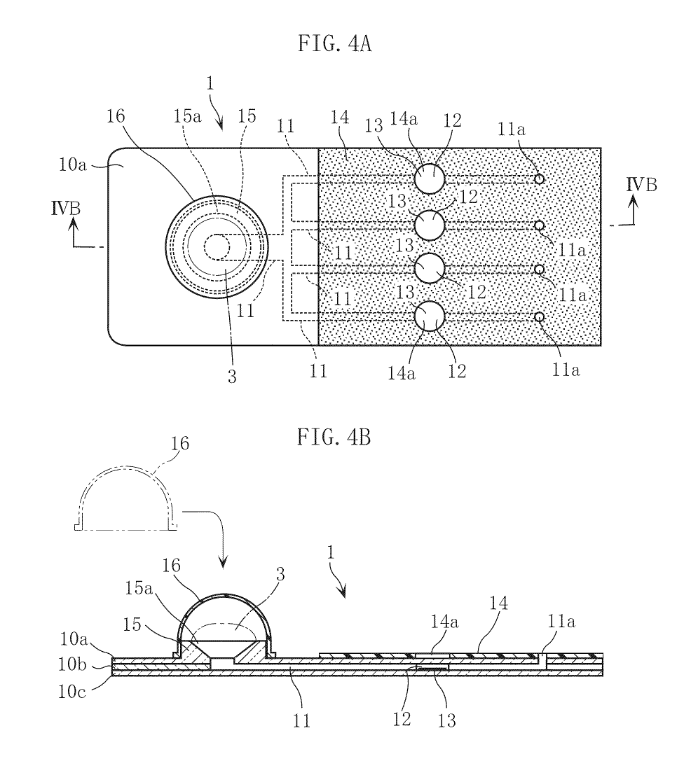

To facilitate understanding, the structure of the chip for analysis 1 is explained first with reference to FIGS. 4A and 4B. However, the basic configuration of the chip for analysis 1 can be the same as the basic configuration of a chip for analysis known in the past (the chip for analysis described in Japanese Patent Application Laid-open No. 2011-021918 and Japanese Patent Application Laid-open No. 2010-276443 explained above). Therefore, the configuration is briefly explained.

The chip for analysis 1 is a disposable type and includes a plurality of reaction chambers 12. In the reaction chambers 12, a reagent 13 for a coloring reaction is arranged. The sample 3 is supplied to the reaction chambers 12, whereby a coloring reaction between the sample 3 and the reagent 13 occurs. A degree of the coloring reaction corresponds to the concentration of a specific component in the sample 3. Therefore, it is possible to calculate the concentration of the specific component in the sample 3 on the basis of an optical characteristic of the coloring reaction. In the figure, an example is shown in which four reaction chambers 12 are provided. It is possible to collectively execute tests of four items concerning the sample 3. However, the number of the reaction chambers 12 is not limited to this. It is also possible that, among the plurality of reaction chambers 12, for example, one reaction chamber 12 is formed as a reaction chamber for reference, in which the reagent 13 is not arranged, to make it possible to test the optical characteristic of the sample 3 in a state in which the sample 3 does not cause the coloring reaction.

The chip for analysis 1 is configured by stacking transparent sheet bodies 10a to 10c and a light blocking cover 14. The plurality of reaction chambers 12 are formed in, for example, a circular shape in plan view. In an upper surface section of the chip for analysis 1, a reservoir section 15 communicating with the plurality of reaction chambers 12 via a plurality of channels 11 is provided. In a state in which the sample 3 is dripped in an opening section 15a of the reservoir section 15, when a cap 16 is attached to the reservoir section 15 and pressed and deformed, the sample 3 branches and flows into the plurality of reaction chambers 12 from the channels 11. Then, the coloring reaction between the sample 3 and the reagent 13 begins. The terminal ends of the channels 11 are formed as hole sections 11a for ventilation.

The light blocking cover 14 is, for example, a black light non-transmissive film. In the light blocking cover 14, opening sections 14a are provided in portions corresponding to positions right above the reaction chambers 12. In analysis processing of the sample 3, an image of the coloring reaction that occurs in the reaction chambers 12 is picked up by the camera 25 of the mobile terminal B from above the opening sections 14a. The opening sections 14a are formed in a circular shape same as the reaction chambers 12. The diameter of the opening sections 14a is the same as or slightly smaller than the diameter of the reaction chambers 12.

As shown in FIGS. 1 and 2, the auxiliary apparatus for analysis C includes a housing 4 of resin, the entire schematic shape of which is formed in, for example, a substantially rectangular parallelepiped shape, a placing section 4a for placing the mobile terminal B, and a chip mounting section 23, light sources 21, a control section 50, a communication circuit 51, a transfer device 52 for a chip for preliminary test 48, and a cap pressing device 53 for pressing the cap 16 of the chip for analysis 1, which are provided in the housing 4.

The housing 4 is formed in, for example, structure in which a lower surface opening section can be opened and closed using a lid body 41. The housing 4 is made of resin. The housing 4 is formed in structure in which disturbance light less easily intrudes into the inside. The chip mounting section 23 is configured by opening and providing an insertion port 23c on a side surface of the housing 4. The chip mounting section 23 includes a placing table 23a for stably fixing and placing the chip for analysis 1 when the chip for analysis 1 is inserted into the insertion port 23c. A temperature control heater 23b is provided in the placing table 23a. It is possible to maintain temperature in causing the coloring reaction between the sample 3 and the reagent 13 in a predetermined temperature range.

The light sources 21 (21a to 21d) are, for example, LED light sources and provided below the chip mounting section 23. The light sources 21a to 21d have center wavelengths of lights different from one another. The center wavelengths of lights respectively emitted from the light sources 21a to 21d are, for example, 405 nm, 450 nm, 570 nm, and 630 nm. The camera 25 mounted on the smartphone includes RGB color filers 25b as explained below. The RGB color filters 25b transmit lights in a wavelength region of 380 to 700 nm in total at high transmittance. The light sources 21 emit lights in such a wavelength region. Preferably, the light sources 21a to 21d can be individually driven to be lit. In the analysis of the sample 3, light having an appropriate center wavelength is selected according to, for example, a type of the coloring reaction. For switching of a wavelength, instead of individually driving to light the light sources 21a to 21d, for example, it is also possible to use a shutter mechanism capable of individually blocking the lights respectively emitted from the light sources 21a to 21d. The lights emitted from the light sources 21 are diffused via a light scattering plate 22 and then substantially uniformly irradiated on the plurality of reaction chambers 12 and a peripheral region of the reaction chambers 12 of the chip for analysis 1 from below the chip for analysis 1.

The upper surface section of the housing 4 is formed as the placing section 4a for the mobile terminal B. In the placing section 4a, for example, positioning guides 42 and 43 shown in FIG. 1 are provided. When the mobile terminal B is placed on the placing section 4a, positioning of the mobile terminal B is possible. The placing section 4a includes a light passing section 41 for allowing light transmitted through the reaction chambers 12 of the chip for analysis 1 to pass and making the light incident on the camera 25 of the mobile terminal B. The light passing section 41 is formed by, for example, providing a through-hole in the upper wall section of the housing 4 configuring the placing section 4a. The light passing section 41 can be closed by a cover member excellent in a light transmitting property to prevent dust and the like from entering the inside from the outside of the housing 4 via the light passing section 41. The positioning guide 42 is a portion for abutting the distal end portion of the mobile terminal B. The other pair of guides 43 is portions for holding the mobile terminal B from both sides thereof. Preferably, the guide 42 is adjustable in the position thereof in the longitudinal direction of the mobile terminal B. The pair of guides 43 is adjustable in the position thereof in the width direction of the mobile terminal B. Consequently, even when a plurality of kinds of the mobile terminals B having entire sizes and positions of the camera 25 different from one another are used, it is possible to appropriately arrange the camera 25 in a position right above the light transmitting section 41.

In FIG. 2, the communication circuit 51 enables radio communication with the mobile terminal B and is adapted to, for example, Wi-Fi. However, data communication may be executed in a state in which the communication circuit 51 and the mobile terminal B are connected by wire. The control section 50 receives a command from the mobile terminal B and performs operation control of the sections of the auxiliary apparatus for analysis C. In the analysis system A in this embodiment, as explained below, it is possible to cause a data processing section 28 of the mobile terminal B to perform the operation control of the sections and arithmetic processing. Therefore, the control section 50 can adopt a configuration in which a relatively small and inexpensive microcomputer is used. Further, the control section 50 can also adopt a configuration in which the microcomputer is not substantially used.

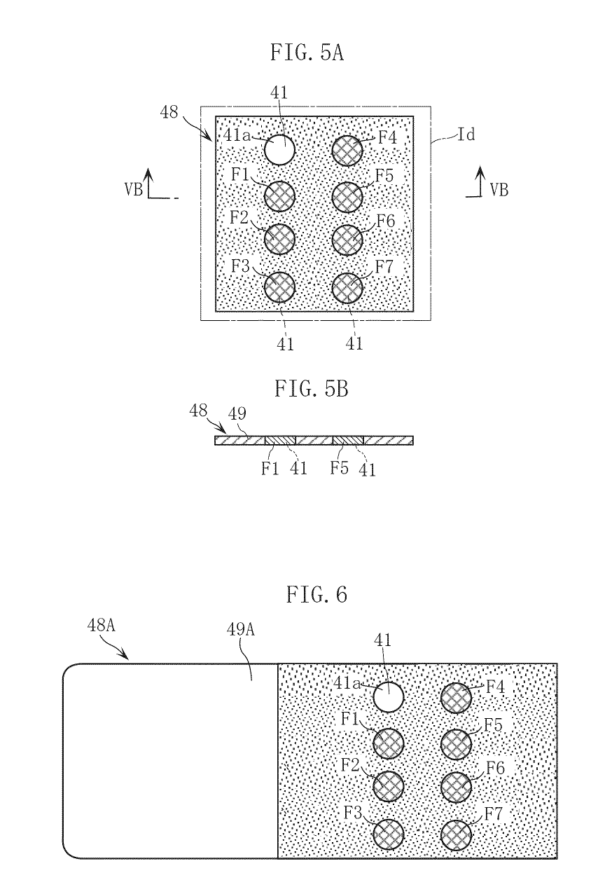

The chip for preliminary test 48 is used for a preliminary test explained below executed prior to analysis processing of the sample 3. The chip for preliminary test 48 includes, as shown in FIGS. 5A and 5B, a chip main body 49 and a plurality of ND filters F1 to F7 inserted into a plurality of through-holes 41 provided in the chip main body 49. A through-hole 41 (41a) not inserted with an ND filter is also provided. Transmittances of lights of the plurality of ND filters F1 to F7 are different from one another. The transmittances gradually decrease in the order of the ND filter F1 to the ND filter F7. Details of the preliminary test performed using the chip for preliminary test 48 are explained below.

The transfer device 52 of the chip for preliminary test 48 is capable of performing, in a state in which the chip for analysis 1 is not mounted on the chip mounting section 23, an operation for arranging the chip for preliminary test 48 in the chip mounting section 23 and an operation for retracting the chip for preliminary test 48 from the chip mounting section 23. In FIG. 2, the transfer device 52 is schematically shown. The chip for preliminary test 48 is shown in a state in which the chip for preliminary test 48 relatively largely moves in the up-down direction. However, actually, for example, the chip for preliminary test 48 only has to be moved substantially horizontally from a position retracted to a side of the chip mounting section 23 (a direction orthogonal to the paper surface of FIG. 2) to be arranged on the chip mounting section 23 and to be moved substantially horizontally from the position on the chip mounting section 23 to the original retracted position. The transfer device 52 can include a mechanism for reciprocatingly moving the chip for preliminary test 48 in the substantially horizontal direction.

However, the transfer device 52 can be omitted. For example, in a chip for preliminary test 48A shown in FIG. 6, a chip main body 49A has a length dimension larger than the length dimension of the chip main body 49 shown in FIGS. 5A and 5B. The user can pinch one end portion of the chip main body 49A and detachably mount the chip main body 49A on the chip mounting section 23 from the outside of the auxiliary apparatus for analysis C. When the chip for preliminary test 48A is used, the transfer device 52 is unnecessary.

The cap pressing device 53 is a device for pressing the cap 16 of the chip for analysis 1. The cap pressing device 53 is configured using a contact member 53a to be brought into contact with an upper part of the cap 16 and an actuator 53b for lifting and lowering the contact member 53a. As explained above, the cap 16 of the chip for analysis 1 is pressed, whereby the sample 3 flows to the reaction chambers 12 side. In the reaction chambers 12, the coloring reaction between the sample 3 and the reagent 13 can be caused.

However, the cap pressing device 53 can be omitted. If the cap 16 is configured to be located on the outside of the housing 4 when the chip for analysis 1 is mounted on the chip mounting section 23 (in FIG. 2, the cap 16 is located in the housing 4), the user can press the cap 16 with a finger. When such a system is adopted, the cap pressing device 53 is unnecessary.

As explained above, the mobile terminal B is, for example, a smartphone. As shown in FIG. 3, the mobile terminal B is the same as the general smartphone except that a control program P1 for sample analysis processing is stored in a storing section 28a of the data processing section 28. That is, the mobile terminal B includes, in addition to the data processing section 28 and the camera 25, a communication circuit 70, a display section 71 configured using a liquid crystal panel or an organic EL panel, an operation section 72 of a touch panel type, and a speaker 73. The data processing section 28 executes operation processing of the sections of the mobile terminal B and data processing. Since the data processing section 28 stores the control program P1 for the sample analysis processing, the data processing section 28 also functions as a concentration calculation processing section that calculates concentration of a specific component of the sample 3. Specific operation control contents by the control program P1 are explained below.

When the sample analysis processing is performed, the camera 25 is used as a light receiving section for receiving lights emitted from the light sources 21 and transmitted through coloring reaction portions 12a. The camera 25 can pick up an image of the coloring reaction portions 12a. Specifically, the camera 25 is configured by combining a condensing lens 25a, the RGB color filters 25b, and an image sensor 25c. The image sensor 25c is an area image sensor such as a CCD or a CMOS. The color filters 25b are provided to respectively correspond to a plurality of light receiving elements of the image sensor 25c. There are three types of the color filters 25b of RGB. Therefore, the image sensor 25c can output, as picked-up image signals, three types of signals having output levels (voltage levels) corresponding to respective received light amounts of RGB. After being amplified by an amplifying section 26, an analog picked-up image signal output from the camera 25 is converted into a digital signal by an A/D conversion section 27 and then input to the data processing section 28.

In a state in which the mobile terminal B is placed on the placing section 4a, an image pickup range of the camera is a range wider than a region where the plurality of reaction chambers 12 of the chip for analysis 1 are provided. Therefore, when picking up an image in a state in which the chip for analysis 1 is mounted on the chip mounting section 23, the camera 25 can collectively pick up images of the plurality of reaction chambers 12 and a peripheral region of the reaction chambers 12. Light received by the camera 25 can be lights emitted from the light sources 21 and transmitted through the chip for analysis 1. Therefore, it is possible to measure absorbance of a predetermined part of the chip for analysis 1 on the basis of a signal level of an image picked up by the camera 25.

A lighting driving time of the light sources 21 can be changed in a plurality of stages. As a picked-up image by the camera 25, a rather bright picked-up image is obtained when the lighting driving time of the light sources 21 is long. A rather dark picked-up image is obtained when the time is short. Colors, brightness, and the like of the coloring reaction portions of the sample 3 and the reagent 13 are not uniform. The lighting driving time of the light sources 21 is controlled such that a picked-up image having brightness optimum for calculating absorbance of the coloring reaction portions is obtained. Alternatively, after a plurality of images having different levels of brightness are picked up, an image determined as optimum is selected out of the images. Absorbance is calculated on the basis of the selected image.

Action of the analysis system A is explained.

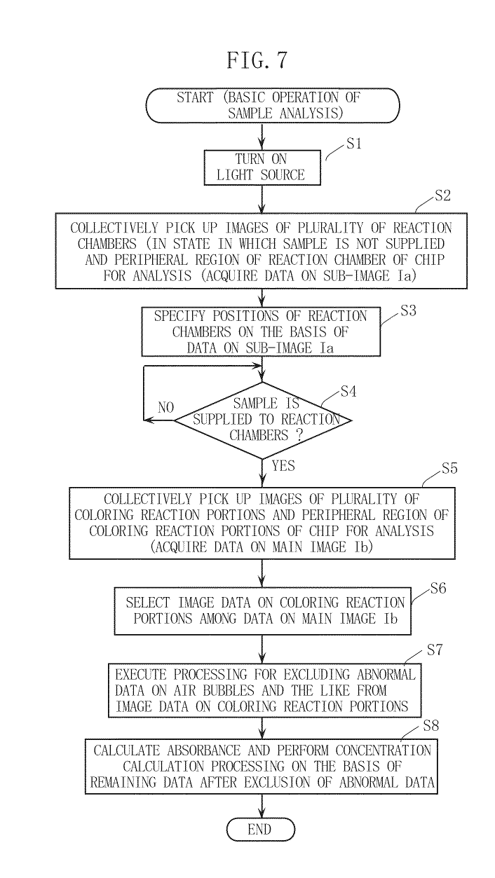

Note that, in the analysis system A in this embodiment, prior to analysis processing of a sample, a preliminary test for testing an output characteristic of the camera 25 is executed. However, to facilitate understanding, the preliminary test is explained below. First, a basic operation processing procedure in picking up the chip for analysis 1 with the camera 25 and calculating concentration of a specific component in the sample 3 is explained with reference to a flowchart of FIG. 7.

### <Basic Operation of a Sample Analysis>

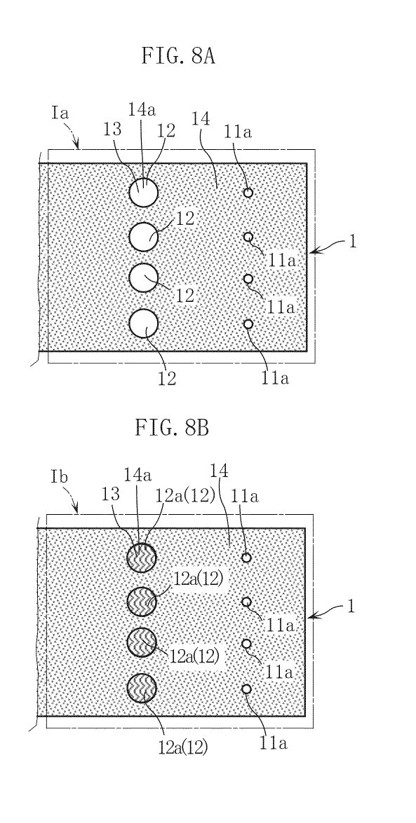

First, in a State in which the Light Sources 21 are not driven to be lit, an image of the plurality of reaction chambers 12 of the chip for analysis 1 is picked up by the camera 25 in a state in which the sample 3 is not supplied yet (S1 and S2). In this case, images of the plurality of reaction chambers 12 and the peripheral region of the reaction chambers 12 are collectively picked up. Consequently, for example, as shown in FIG. 8A, data on a sub-image Ia obtained by collectively picking up images of the plurality of reaction chambers 12 and the peripheral region of the reaction chambers 12 in the chip for analysis 1 is obtained.

Whereas the peripheral region of the reaction chambers is the black light blocking cover 14, the reaction chambers 12 are portions having a light transmitting property, although having the reagent 13 on the insides. The data processing section 28 specifies, using a difference between the light transmitting properties of the reaction chambers 12 and the peripheral region of the reaction chambers 12, the positions of the reaction chambers 12 in the data on the sub-image Ia (S3). However, details of this step are explained below. When the sub-image Ia is picked up, only any one of the light sources 21a to 21d has to be driven to be lit. Thereafter, when the sample 3 is supplied to the reaction chambers 12, the sample 3 and the reagent 13 are mixed in the reaction chambers 12 to cause a coloring reaction. Even in a state in which the coloring reaction is caused, the image pickup by the camera 25 is performed. Consequently, for example, as shown in FIG. 8B, data on a main image Ib obtained by collectively picking up images of all of the coloring reaction portions 12a (the reaction chambers 12) and a peripheral region of the coloring reaction portions 12 is obtained (S4: YES and S5). Image pickup ranges of the main image Ib and the sub-image Ia are the same. The main image Ib and the sub-image Ia are only different in whether the coloring reaction is caused in the reaction chambers 12.

After the main image Ib is picked up, the data processing section 28 selects image data on the coloring reaction portions 12a out of the image data (S6). The selection processing is performed by selecting, out of the data on the main image Ib, data in which the positions of the reaction chambers 12 are the same as the positions of the reaction chambers 12 specified in step S3. In the data on the main image Ib, it is likely that a brightness difference between the coloring reaction portions 12a and the peripheral region of the coloring reaction portions 12a decreases. Processing for accurately specifying the positions of the coloring reaction portions 12a is complicated. However, according to the processing method in this embodiment, such a deficiency is solved.

Subsequently, the data processing section 28 executes processing for excluding abnormal data such as image data on air bubbles and dust and the like from the data on the image of the coloring reaction portions 12a (S7). Although not shown in the figure, when an air bubble is mixed in the coloring reaction portions 12a, a peripheral edge portion of the air bubble reflects, at high reflectance, lights traveling from the light sources 21. Therefore, in a picked-up image, a peripheral edge portion of an image of the air bubble is an image darker than an image region of the normal coloring reaction portions. On the other hand, a portion closer to the center of the air bubble has a characteristic of transmitting most of the lights traveling from the light sources 21. A portion closer to the center of an image 5 of the air bubble is an image of a so-called white void state. Therefore, it is possible to determine presence or absence of such an image and, if a pertinent image is present, exclude the image in this portion as abnormal data on an image of an air bubble or the like.

After excluding the abnormal data among the data on the image of the coloring reaction portions 12a, the data processing section 28 calculates concentration of the specific component of the sample 3 on the basis of the remaining data (S8). This calculation processing is performed by, after calculating absorbance of the coloring reaction portions 12a first, collating the absorbance with data on a calibration curve stored in the storing section 28a.

### <Position Specifying Processing of the Reaction Chambers 12>

In the series of operation procedure explained above, the processing for specifying the positions of the reaction chambers 12 in step S3 is executed using, for example, a method explained below.

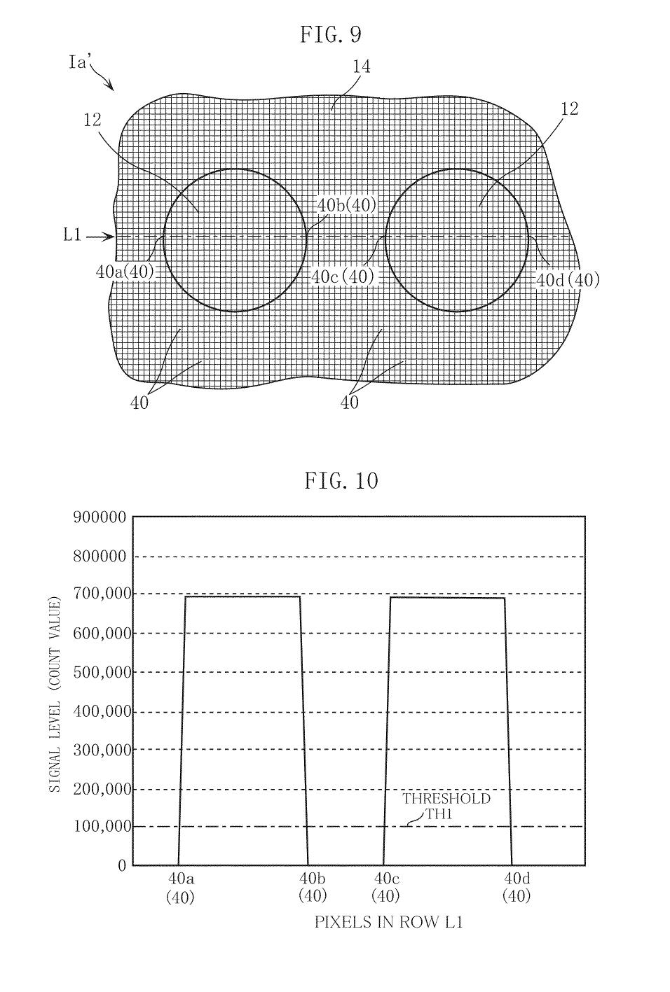

First, an image Ia′ shown in FIG. 9 is a schematically-shown image of a part of the sub-image Ia (an image of two reaction chambers 12 and a peripheral regions of the reaction chambers 12) and is an aggregate of a plurality of pixels 40 (fine squares surrounded by lattices in the figure are respectively equivalent to the pixels 40). In the figure, a signal level of the pixels 40 in a row L1 is in a state shown in FIG. 10. In the figure, the signal level is indicated by a “count value”. The “count value” is a value obtained by digitizing, according to a fixed rule, a level of an analog signal output from the camera 25. As the count value is larger, the signal level of the pixels 40 is higher (the pixels 40 are brighter).

In the figure, among the plurality of pixels 40 in the row L1, the signal level of the pixels 40 located between pixels 40a and 40b and pixels 40c and 40d equivalent to the region of the reaction chambers 12 is high. The signal level of the other pixels 40 is low. This is because, whereas the reaction chambers 12 have a light transmitting property, the light blocking cover 14 is located in the peripheral region of the reaction chambers 12.

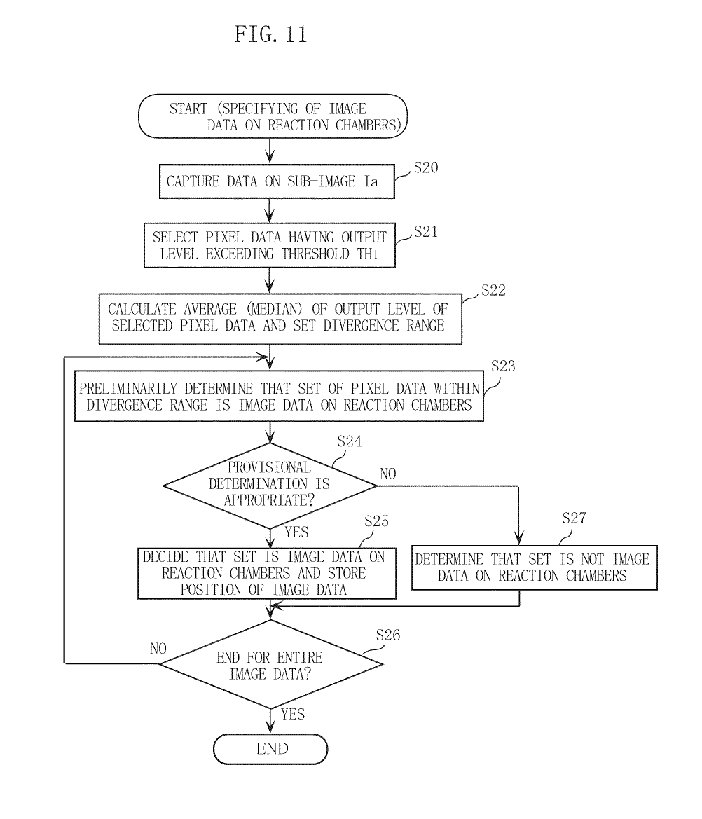

Under the situation explained above, the data processing section 28 executes operation processing shown in a flowchart of FIG. 11.

After capturing the data on the sub-image Ia, the data processing section 28 sets a predetermined count value (e.g., in FIG. 10, a count value “100,000”) as a threshold TH1 and selects, out of data on the plurality of pixels 40, pixel data having a signal level exceeding the threshold TH1 (S20 and S21). Consequently, pixel data with a large received light amount is selected. Subsequently, the data processing section 28 calculates an average or a median of the signal level of the pixel data selected in that way and then sets a divergence range (a dispersion range) on the basis of the average or the median and preliminarily determines that a set of image data within the divergence range is data on the image of the reaction chambers 12 (S22 and S23).

Thereafter, the data processing section 28 determines appropriateness of the provisional determination (S24). In the determination, for example, the data processing section 28 determines whether the size and the position of the data preliminarily determined as the data on the image of the reaction chambers 12 do not greatly deviate from predetermined ranges. When the size and the position of the data are clearly abnormal, the data processing section 28 determines that the data is not the data on the image of the reaction chambers 12 (NO in S24 and S27). Consequently, the data processing section 28 is prevented from erroneously determining that, for example, the hole sections 11a for ventilation of the chip for analysis 1 and the region around the chip for analysis 1 are the reaction chambers 12. When determining that the provisional determination is appropriate, the data processing section 28 finalizes the determination and stores the position of the data on the image of the reaction chambers 12 is stored in the storing section 28a (S24: YES and S25). The processing is repeatedly executed until the processing ends concerning all the data on the sub-image Ia (S26). Therefore, the respective positions of the plurality of reaction chambers 12 are appropriately specified.

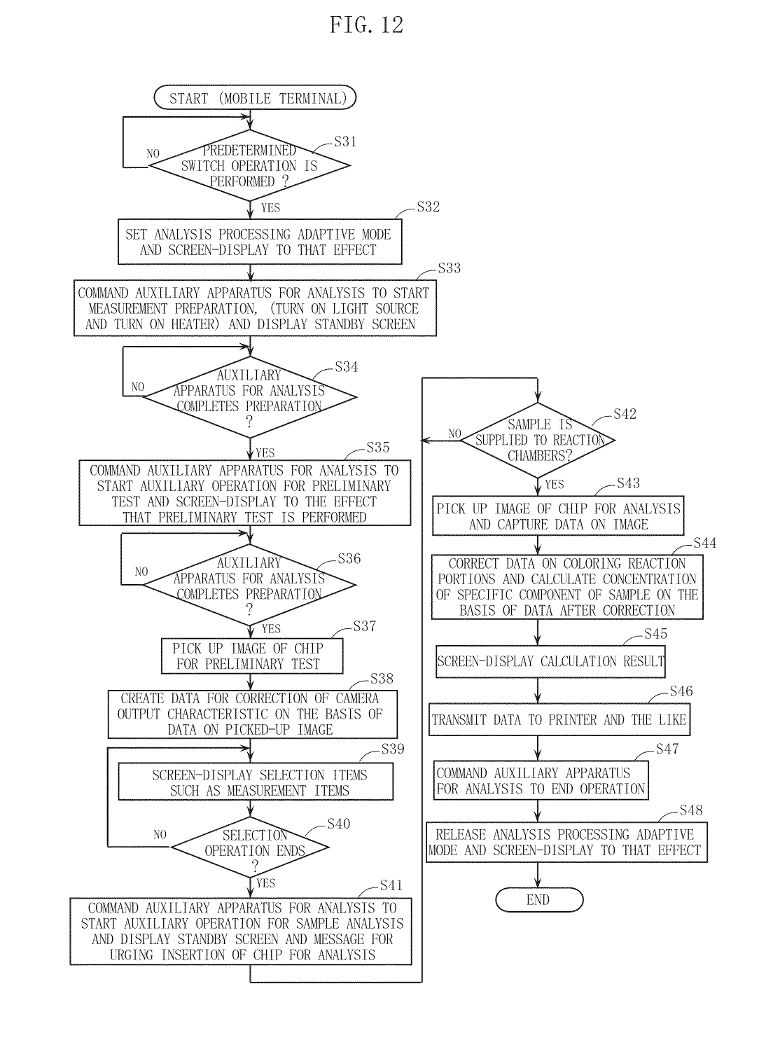

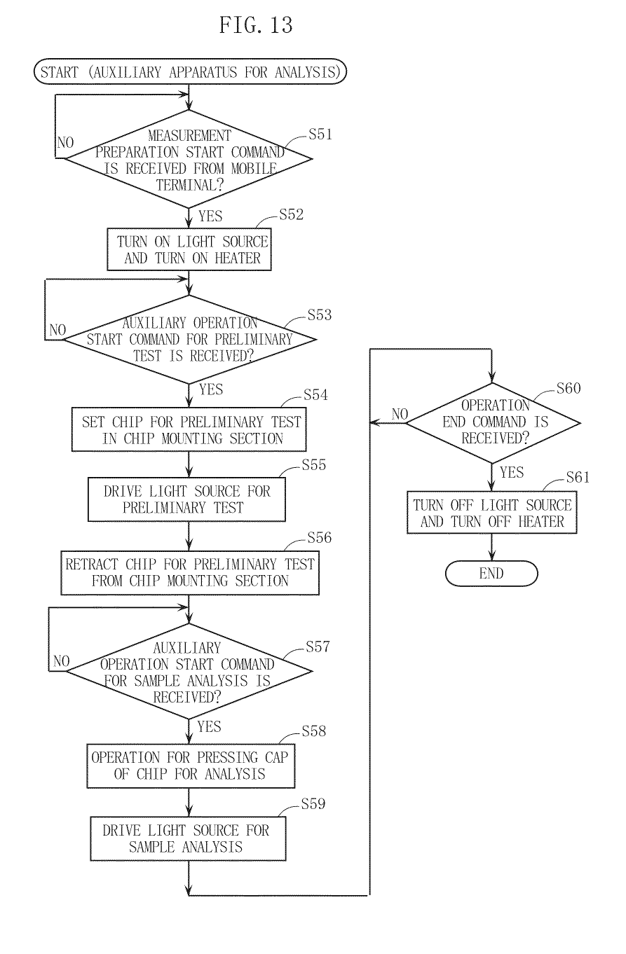

A series of specific operation processing procedure by cooperation of the mobile terminal B and the auxiliary apparatus for analysis C is explained with reference to flowcharts of FIGS. 12 and 13.

### <Cooperative Operation of the Mobile Terminal and the Auxiliary Apparatus for Analysis>

First, when predetermined switch operation is performed by the user in the operation section 72 of the mobile terminal B, the mobile terminal B is set in an analysis processing adaptive mode. Screen display indicating to that effect is performed on the display section 71 (S31: YES and S32). Note that, as a condition for setting the mobile terminal B in the analysis processing adaptive mode, instead of the switch operation, when the mobile terminal B and the auxiliary apparatus for analysis C are connected for communication via a wire according to specifications, the wire connection may be set. When the mobile terminal B is set in the analysis processing adaptive mode, the data processing section 28 performs data transmission for commanding the auxiliary apparatus for analysis C to start measurement preparation and causes the display section 71 to display a standby screen (S33). In response to the command, in the auxiliary apparatus for analysis C, both of the light source 21 and the temperature control heater 23b are turned on (S51: YES and S52).

When the measurement preparation is completed in the auxiliary apparatus for analysis C, the data processing section 28 performs data transmission for commanding the auxiliary apparatus for analysis C to perform an auxiliary operation for the preliminary test and causes the display section 71 to perform screen display indicating to the effect that the preliminary test is about to be executed (S34: YES and S35). The data processing section 28 can determine, for example, by causing the auxiliary apparatus for analysis C to transmit a signal indicating to the effect that the measurement preparation is completed, whether the measurement preparation is completed in the auxiliary apparatus for analysis C. The data processing section 28 may determine that the measurement preparation is completed at a point in time when a predetermined time elapses after the start of the measurement preparation is commanded.

The preliminary test is a test for testing a relation between a received light amount of the camera 25 and an output signal of the camera 25 and acquiring data for correction for correcting the relation to a linear relation. In an output characteristic of the camera 25 mounted on the mobile terminal B, a correlation between the received light amount and the output signal is usually nonlinear from the viewpoint of allowing human eyes to clearly view a picked-up image. Therefore, it is demanded to reduce a measurement error due to the output characteristic. The preliminary test meets such a demand.

In the auxiliary apparatus for analysis C, when the command for performing the auxiliary operation for the preliminary test is received from the data processing section 28, the control section 50 causes the user to mount the chip for preliminary test 48 on the chip mounting section 23 (S53: YES and S54). The control section 50 drives to light the light sources 21 to perform the preliminary test (S55). The lighting driving of the light sources 21 in this case is performed to sequentially drive the plurality of light sources 21 (21a to 21d) independently from one another. In that case, the control section 50 repeats the independent driving of the light sources 21 a plurality of times while changing an exposure time or an ISO of the camera 25. On the other hand, when the lighting driving of the light sources 21 is performed, an image of the chip for preliminary test 48 is picked up using the camera 25 (S36: YES and S37). A range of a picked-up image Id of the chip for preliminary test 48 is, for example, a range shown in FIGS. 5A and 5B. An image of the plurality of ND filters F1 to F7, the through-hole 41a, and a peripheral portion of the ND filters F1 to F7 and the through-hole 41a is picked up. It is possible to exclude image data on the peripheral portion according to a method same as the method explained above and select or differentiate only data concerning the plurality of ND filers F1 to F7 and the through-hole 41a. The data processing section 28 creates data for correction of the camera output characteristic on the basis of such data on the picked-up image (S38). A method for creating the data for correction is as explained below.

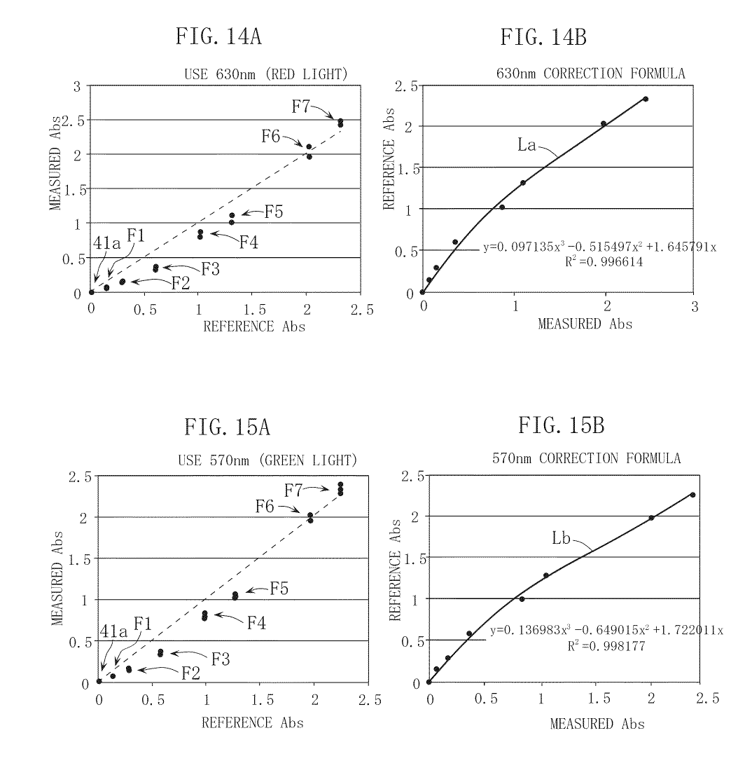

First, data shown in FIG. 14A is created. The data shown in the figure is obtained by calculating, from a picked-up image obtained by driving the light source 21d and irradiating light (red light) having a center wavelength of 630 nm on the chip for preliminary test 48, absorbance (measured Abs) of the plurality of ND filers F1 to F7 and plotting the absorbance (dots indicated by signs F1 to F7 in the figure indicate measured Abs of the ND filers F1 to F7 in FIGS. 5A and 5B). The data shown in the figure is obtained by performing the image pickup of the chip for preliminary test 48 three times. The absorbance of the through-hole 41a of the chip for preliminary test 48 is zero. A signal of a picked-up image of the through-hole 41a is used as a calculation reference for measured Abs. As shown in FIG. 14A, it can be understood that the measured Abs is nonlinear and the received light amount and the output signal of the camera 25 are not in a linear relation.

Subsequently, to create data for correction, data shown in FIG. 14B is created on the basis of the data shown in FIG. 14A. The data is obtained by replacing the ordinate and the abscissa of the graph shown in FIG. 14A. In FIG. 14B, a curve La is an approximation curve of the measured Abs of the ND filters F1 to F7. An equation of the approximation curve La is, for example, as indicated by the following Expression 1:

y=0.097135x³−0.515497x²+1.645791x Expression 1

Dispersion is R²=0.996614. When such an equation of the approximation curve is obtained, a value of accurate absorbance with little error can be obtained by substituting a value of the measured Abs as a value of x of the equation. Therefore, Expression 1 is equivalent to an example of the data for correction in the present invention.

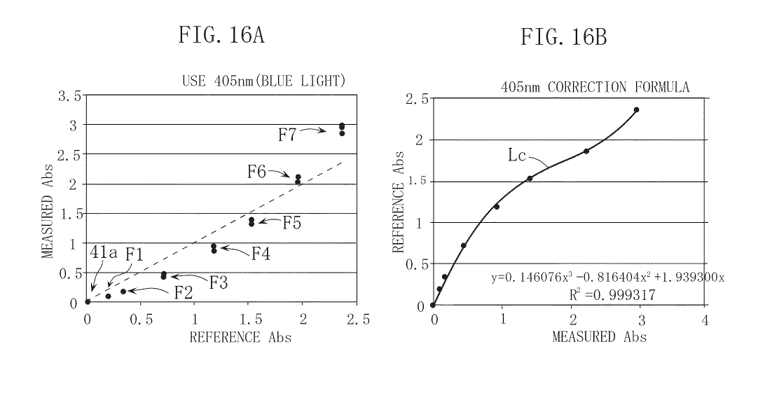

In the example explained above, the red light having the center wavelength of 630 nm emitted from the light source 21d is explained. However, concerning lights in other wavelength regions emitted from the other light sources 21a to 21c, an equation serving as data for correction is calculated using a method same as the method explained above. Explanation concerning blue reaction between from the light source 21a is omitted for convenience. However, green light having a center wavelength of 570 nm emitted from the light source 21c and blue light having a center wavelength of 405 nm emitted from the light source 21b are, for example, data shown in FIGS. 15 and 16. Examples of equations for obtaining accurate absorbance (equations of approximation curves Lb and Lc) are the following Expressions 2 and 3:

y=0.136983x³−0.649015x+1.722011x Expression 2

Dispersion is R²=0.998177.

y=0.146076x³−0.816404x²+1.939300x Expression 3

Dispersion is R²=0.999317.

After calculating the data for correction explained above, the data processing section 28 displays measurement items (e.g., AMY (amylase) measurement, TG (neutral fat) measurement, and blood sugar level measurement) and items related thereto on the display section 71 and causes the user to select measurement items desired by the user (S39). When the selection operation ends, the data processing section 28 commands the auxiliary apparatus for analysis C to execute an auxiliary operation for sample analysis and causes the display section 71 to display a standby screen (S40: YES and S41). In that case, preferably, for example, a message for urging the user to mount the chip for analysis 1 on the chip mounting section 23 is displayed to the user. Note that, in the auxiliary apparatus for analysis C, in a stage when the image pickup of the chip for preliminary test 48 is finished, an operation for returning the chip for preliminary test 48 to the original standby state is performed to prevent the mounting of the chip for analysis 1 from being hindered (S56). When receiving the auxiliary operation execution command for the sample analysis, the auxiliary apparatus for analysis C executes an operation for pressing the cap 16 of the chip for analysis 1 to perform light source lighting driving for the sample analysis (S57: YES, S58, and S59). In this case, the light source 21 to be driven to be lit is a light source that emits light having a center wavelength desirable for a measurement item of a sample.

When the sample 3 is supplied to the reaction chambers 12 by the pressing of the cap 16, thereafter, the coloring reaction occurs in the reaction chambers 12. At such timing, an image of the chip for analysis 1 is picked up by the camera 25 and data on the image is captured into the data processing section 28 (S42: YES and S43). Thereafter, as explained with reference to FIG. 7 and the like, the data processing section 28 selects image data on the coloring reaction portions 12a out of the picked-up image data and calculates absorbance of the coloring reaction portions 12a. The data processing section 28 corrects a value of the absorbance using the data for correction and calculates concentration of a specific component of the sample 3 on the basis of the absorbance after the correction (S44). The data processing section 28 causes the display section 71 to display and output data on an analysis result obtained in this way together with measurement target items and other related matters, transmits the data by radio to a printer 90 (see FIG. 1) registered in advance in the mobile terminal B, and causes the printer 90 to print and output the data (S46). Naturally, it is also possible to transmit the data to an apparatus or a device such as the personal computer 91 other than the printer 90 and perform data management. Further, by registering an address on a network in the mobile terminal B, it is also possible to transmit the data to the registered address.

When the data transmission of the analysis result or the like ends, the data processing section 28 issues a command for an operation end to the auxiliary apparatus for analysis C and thereafter releases the analysis processing adaptive mode of the mobile terminal B. In that case, the data processing section 28 causes the display section 71 to display to the effect that the analysis processing adaptive mode ends and thereafter returns the mobile terminal B to screen display in a normal state (S47, S48). In the auxiliary apparatus for analysis C, when the command for the operation end is received, the control section 50 turns off the light sources 21 and the temperature control heater 23b (S60: YES and S61).

### <Advantages and the Like>

In the analysis system A in this embodiment, the camera 25 and the data processing section 28 of the mobile terminal B are used as the light receiving section, which receives light transmitted through the coloring reaction portions 12a and the like, and the concentration calculation processing section. Therefore, in the auxiliary apparatus for analysis C, it is unnecessary to provide means equivalent to the light receiving section and the concentration calculation processing section. As means for outputting the data on the analysis result, the display section 71 of the mobile terminal B can be used. Besides, means for transmitting the data to the printer 90 or the like on the outside as appropriate can be simply adopted using a communication function originally included in the mobile terminal B. It is also unnecessary to include the printer 90 in the auxiliary apparatus for analysis C. It is possible to simplify the entire configuration of the auxiliary apparatus for analysis C. On the other hand, the mobile terminal B is not specialized as a device configuring the analysis system A. The mobile terminal B can be used without hindering telephone call, mail transmission and reception, Internet connection, and the like. As a result, for example, compared with an analysis system entirely configured by dedicated devices, the analysis system A in this embodiment has a streamlined configuration in which the mobile terminal B is effectively used. Therefore, it is possible to reduce substantial manufacturing costs of the entire system. It is also possible to facilitate a reduction in the size of the entire system and improve handlability of the system.

Since the sections of the auxiliary apparatus for analysis C are controlled via the data processing section 28 of the mobile terminal B, it is possible to eliminate a trouble that a large number of operation switches are provided in the auxiliary apparatus for analysis C and the user operates the operation switches. Therefore, operation is easy and convenience of use is high.

When an image of the coloring reaction portions 12a of the chip for analysis 1 is picked up by the camera 25, an image of not only the coloring reaction portions 12a but also the peripheral region of the coloring reaction portions 12a is picked up. Therefore, it is unnecessary to highly accurately perform alignment of the camera 25 and the coloring reaction portions 12a such that the camera 25 picks up an image of only the coloring reaction portions 12a. It is also possible to collectively pick up and process images of the plurality of coloring reaction portions 12a provided in the chip for analysis 1. Therefore, it is also possible to increase measurement speed. It is also unnecessary to move the positions of the light sources 21 and the camera 25 of the mobile terminal B to places respectively corresponding to the plurality of coloring reaction portions 12a.

The signal level of the picked-up image output from the camera 25 is in a nonlinear relation with the received light amount of the camera 25. However, in this embodiment, the correction processing for eliminating such a relation is executed. Therefore, it is possible to make the data on the analysis result considerably accurate.

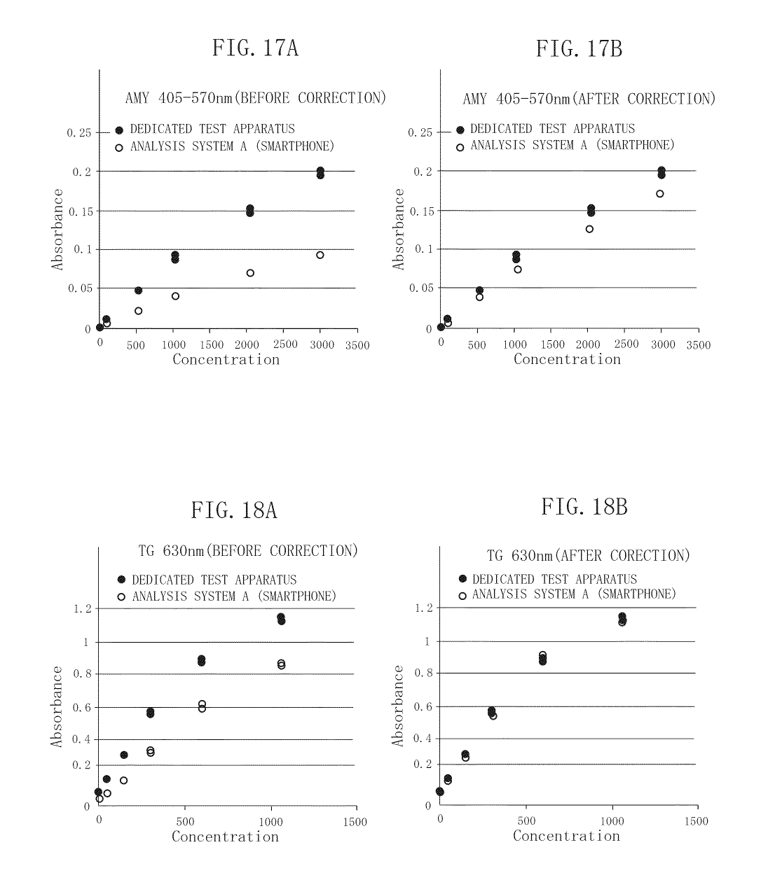

FIGS. 17A and 17B and FIGS. 18A and 18B show specific examples of absorbance calculated by performing correction processing and absorbance calculated without performing the correction processing.

FIG. 17A is shows an example in which absorbance of AMY is calculated using the analysis system A (the normal smartphone is used as the mobile terminal B). However, data correction is not performed. In this case, a difference between the absorbance and absorbance of the AMY obtained by using a highly accurate dedicated test apparatus is considerably large. On the other hand, as shown in FIG. 17B, when the analysis system A is used and the correction is performed, a value of absorbance of the AMY is considerably close to the absorbance of the AMY obtained by using the dedicated test apparatus.

FIGS. 18A and 18B show an example in which TG is set as a target instead of the AMY and absorbance of the TG is calculated. Compared with absorbance obtained when correction is not performed (FIG. 18A), when the correction is performed (FIG. 18B), a value of absorbance of the TG is considerably close to a value of absorbance obtained by using the dedicated test apparatus.

As it is understood from such examples, in the analysis system A in this embodiment, it is possible to suitably solve a deficiency that accuracy of an analysis result decreases because of the output characteristic of the camera 25. It is possible to obtain a highly accurate and reliable analysis result.

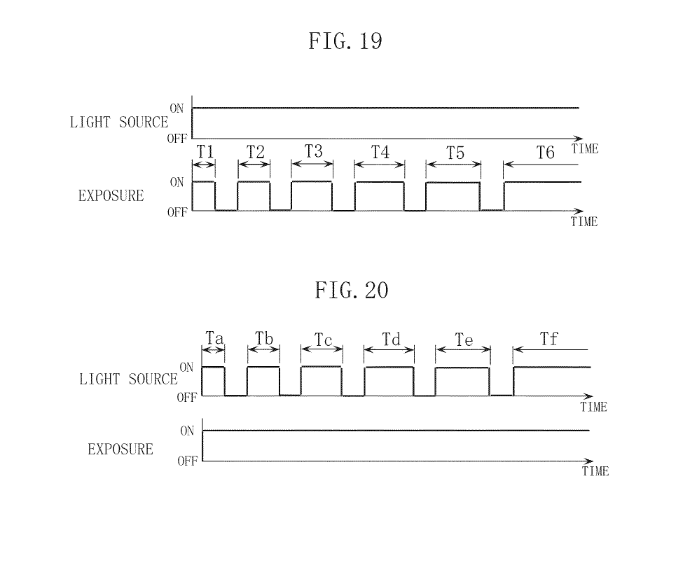

FIG. 19 and FIG. 20 show other examples of the method for calculating data for correction.

In the methods shown in the figures, it is unnecessary to use the chip for preliminary test 48 including the ND filters F1 to F7. An image of lights emitted from the light sources 21 is directly picked up by the camera 25. However, in the method shown in FIG. 19, the lighting driving time of the light sources 21 is increased and exposure times T1, T2, T3, and the like of the camera 25 are sequentially changed during a lighting driving period of the light sources 21. In such a form, a received light amount of the camera 25 changes in a plurality of stages. It is possible to obtain action same as the action obtained when the received light amount of the camera 25 is changed in the plurality of stages using the ND filters F1 to F7. It is possible to obtain date for correction according to the processing shown in FIGS. 14A to 16B.

In the method shown in FIG. 20, the exposure time of the camera 25 is increased and lighting driving times Ta, Tb, Tc, and the like of the light sources 21 are sequentially changed during an exposure period. In such a form, as in the form explained above, a received light amount of the camera 25 changes in a plurality of stages. Therefore, as in the case of FIG. 19, it is possible to obtain data for correction according to the processing shown in FIGS. 14A to 16B. When data for correction is obtained by the methods shown in FIG. 19 and FIG. 20, it is desirable to change an ISO, cause the camera 25 to perform an image pickup operation a plurality of times, and acquire a large number of sample data.

The present invention is not limited to the contents of the embodiment explained above. The specific configurations of the sections of the analysis system, the auxiliary apparatus for analysis, and the mobile terminal according to the present invention can be variously changed within the intended scope of the present invention. The specific contents of the control program according to the present invention can also be variously changed within the intended scope of the present invention.

In the embodiment, as the means for specifying data on an image of the coloring reaction portion, the processing for specifying the positions of the reaction chambers 12 is executed in the state in which the sample 3 is not supplied to the reaction chambers 12. However, the means is not limited to this. In the present invention, the positions of the reaction chambers 12 (the positions of the coloring reaction portions 12a) may be specified on the basis of a picked-up image obtained after the sample 3 is supplied to the reaction chambers 12. If the peripheral region of the reaction chambers 12 is colored in black or a color close to black, it is possible to set a contrast between the peripheral region and a sample such as blood relatively large and appropriately distinguish the coloring reaction portions 12a and the peripheral region of the coloring reaction regions 12a.

Note that, as the method for specifying the positions of the reaction chambers 12, it is possible to use a method for calculating a center position of a bright image region in a picked-up image of a reaction chamber and a peripheral region of the reaction chamber and setting a region within a predetermined radius from the center as a reaction chamber. Further, as a method different from this method, it is also possible to use a method for calculating a difference (or differential) of respective signal levels of a continuously arranged plurality of pixels and sets a place where a value of the difference suddenly changes at width equal to or larger than predetermined width as a boundary portion between a reaction chamber and a peripheral region of the reaction chamber. This is because, in the reaction chamber and the peripheral region of the reaction chamber, a signal level of image data suddenly changes because of a difference between optical characteristics of the reaction chamber and the peripheral region.

In the present invention, instead of picking up an image of the chip for analysis using light transmitted through the chip for analysis, it is also possible to pick up an image of the chip for analysis using light reflected by the chip for analysis. When the optical characteristic of the coloring reaction between the sample and the reagent is tested, it is also possible to perform a test based on light reflectance and a color of the coloring reaction portions 12a instead of or in addition to a light absorption characteristic of the coloring reaction portions 12a.

The auxiliary apparatus for analysis is desirably controlled via the data processing section of the mobile terminal. However, the control of the auxiliary apparatus for analysis is not limited to this. For example, it is also possible to provide an operation switch in the auxiliary apparatus for analysis and cause the auxiliary apparatus for analysis to perform a predetermined operation according to operation of the operation switch. A specific type of the mobile terminal may be any type. Instead of the smartphone, a cellular phone, a tablet terminal, and the like can also be used. The mobile terminal only has to be a mobile terminal including a camera and a data processing section. As the sample, besides the blood, for example, urine can be used. A specific type of the sample may be any type.

What is claimed is:

1. An analysis system comprising:
a chip mounting section on which a chip for analysis for causing a coloring reaction between a sample and a reagent is mounted;
a light source for irradiating light on a coloring reaction portion of the chip for analysis mounted on the chip mounting section;
a light receiving section that receives transmitted light or reflected light in the coloring reaction portion, emitted from the light source, and that outputs a signal corresponding to an amount of the received light; and
a concentration calculation processing section that executes concentration calculation processing on a specific component in the sample on the basis of data on the signal output from the light receiving section,
the analysis system being configured by combining a mobile terminal equipped with a camera and an auxiliary apparatus for analysis,
the auxiliary apparatus for analysis including a placing section, on which the mobile terminal can be placed, and having a configuration in which the chip mounting section and the light source are provided below the placing section,
the mounting section including a light passing section for making the transmitted light or the reflected light in the coloring reaction portion, emitted from the light source, incident on the camera of the mobile terminal in a state in which the mobile terminal is placed on the placing section,
the camera of the mobile terminal being used as the light receiving section, and
a data processing section that is included in the mobile terminal being used as the concentration calculating processing section and, when the transmitted light or the reflected light in the coloring reaction portion passes through the light passing section and is made incident on the camera, being capable of executing the concentration calculation processing on the basis of data on a picked-up image signal output from the camera.

2. The analysis system according to claim 1, wherein
the auxiliary apparatus for analysis further includes a communication circuit capable of performing wired or wireless data communication with the mobile terminal, and
a control signal is transmitted to the communication circuit from the mobile terminal to control a light emitting operation of the light source.

3. The analysis system according to claim 1, wherein the mobile terminal is capable of transmitting data concerning a result of the concentration calculation processing to a printer designated in advance, an apparatus or a device other than the printer, or to a desired address on a network.

4. The analysis system according to claim 1, wherein
the camera is enabled to pick up an image of a range wider than the coloring reaction portion in the chip for analysis and obtain, as data on a picked-up image by the camera, data on a main image obtained by collectively picking up images of the coloring reaction portion and a peripheral region of the coloring reaction portion, and
the data processing section selects data on an image of the coloring reaction portion from the data on the main image and executes the concentration calculation processing on the basis of the selected data.

5. An auxiliary apparatus for analysis comprising:
a chip mounting section on which a chip for analysis for causing a coloring reaction between a sample and a reagent is mounted;
a light source for irradiating light on a coloring reaction portion of the chip for analysis mounted on the chip mounting section; and
a placing section on which a mobile terminal equipped with a camera can be placed,
the chip mounting section and the light source being provided below the placing section, and
the mounting section including a light passing section for making the transmitted light or the reflected light in the coloring reaction portion incident on the camera of the mobile terminal in a state in which the mobile terminal is placed on the placing section.

6. A mobile terminal comprising:
a camera; and
a data processing section capable of executing data processing on a picked-up image signal output from the camera,
the mobile terminal being used in combination with the auxiliary apparatus for analysis according to claim 5 to constitute an analysis system capable of executing concentration calculation processing on a specific component in a sample,
the data processing section setting, when predetermined operation is performed, the mobile terminal in an analysis processing adaptive mode being capable of executing, during the setting of the analysis processing adaptive mode, when transmitted light or reflected light in a coloring reaction portion, emitted from a light source on a side of the auxiliary apparatus for analysis, is made incident on the camera and an image of the coloring reaction portion is picked up, the concentration calculation processing on the basis of data on the picked-up image signal output from the camera.

7. The mobile terminal according to claim 6, wherein
the mobile terminal is capable of performing data communication with a communication circuit included in the auxiliary apparatus for analysis, and
when the analysis processing adaptive mode is set, the data processing section transmits a command signal for activating a light source of the auxiliary apparatus for analysis to the communication circuit and then, after confirmation is made that the coloring reaction portion is constructed in the chip for analysis mounted on a chip mounting section of the auxiliary apparatus for analysis, executes control of activating the camera to pick up an image of the coloring reaction portion.

8. The mobile terminal according to claim 6, wherein
in a stage before the chip for analysis is mounted on the chip mounting section of the auxiliary apparatus for analysis, a preliminary test for testing an output characteristic of the camera is possible,
in the preliminary test, the camera is caused to receive reaction between from the light source and, when the camera receives the light, an amount of light received by the camera is set to change in a plurality of stages, thereby checking values of a plurality of output signals output from the camera according to the received light amount that changes in the plurality of stages,
after the preliminary test, correction data for correcting the values of the plurality of output signals to conform to a linear relation in a correlation with the received light amounts in the plurality of stages of the camera is calculated, and
when transmitted light or reflected light in the coloring reaction portion is received by the camera and a picked-up image signal is output from the camera, data on the output signal or data corresponding to the data is corrected on the basis of the data for correction, and concentration of a specific component in the sample is calculated on the basis of the data after the correction.

9. The mobile terminal according to claim 8, wherein, in the preliminary test, a operation in which the amount of light received by the camera changes in the plurality of stages is performed by causing the reaction between from the light source to pass through each of a plurality of ND filters having different transmittances and making the light incident on the camera, and changing an exposure time of the camera in a plurality of stages, or changing a light emission time of the light source in a plurality of stages.

10. A control program for a mobile terminal stored, in a mobile terminal including a camera and a data processing section capable of executing data processing on a picked-up image signal output from the camera, in a storing section of the data processing section and used for constituting an analysis system capable of executing concentration calculation processing on a specific component in a sample by using the mobile terminal in combination with the auxiliary apparatus for analysis according to claim 5,
the control program for the mobile terminal including data for causing the data processing section to execute:
a step of setting the mobile terminal in an analysis processing adaptive mode when predetermined operation is performed; and
a step of executing, during the setting of the analysis processing adaptive mode, when transmitted light or reflected light in a coloring reaction portion, emitted from a light source on a side of the auxiliary apparatus for analysis, is made incident on the camera and an image of the coloring reaction portion is picked up, the concentration calculation processing on the basis of data on the picked-up image signal output from the camera.
